(19) United States
(12) Patent Application Publication
(10) Pub. No.: US 2023/0278731 A1
(43) Pub. Date: Sep. 7, 2023

(54) AIRFRAME AND MOTOR ASSEMBLY FOR AN UNMANNED AIRCRAFT

(71) Applicant: AERIAL RESPONSE SOLUTIONS, LLC ("ARS"), Rockville, MD (US)

(72) Inventors: Michael DORNISCH, Marlton, NJ (US); Max TUBMAN, Philadelphia, PA (US); Evan PANEK, Philadelphia, PA (US); Conor MCCAFFREY, Pennsauken, NJ (US)

(21) Appl. No.: 18/019,899

(22) PCT Filed: Sep. 2, 2021
(86) PCT No.: PCT/US2021/048844

§ 371 Date: Feb. 6, 2023

Related U.S. Application Data
(60) Provisional application No. 63/074,036, filed on Sep. 3, 2020.

(51) Int. Cl. B64U 20/75; B64U 10/14; B64C 1/16; B64U 30/29

(52) U.S. Cl. CPC B64U 20/75; B64U 10/14; B64C 1/16; B64U 30/29

(57) ABSTRACT

An unmanned aerial vehicle (UAV), comprising a fuselage outer shell defining a lateral axis, a longitudinal axis and a plurality of shell sides; fuselage center assembly positioned within a cavity defined by the fuselage outer shell; and a rotor arm and joint assembly. The plurality of the shell sides are concave with respect to the lateral axis or the longitudinal axis. The fuselage center assembly includes a lattice center defining a superior surface and an inferior surface as well as a plurality of channels, each channel having a proximal end and a distal end, wherein each proximal end is coupled to the superior surface and the inferior surface. The rotor arm has a proximal end and a distal end. A motor and rotor system is coupled to the distal end of the rotor arm. The rotor arm joint is coupled to the proximal end of the rotor arm, and the rotor arm joint further comprises an outer shell; and a plurality of quick release latches coupled to the outer shell and configured to coule the rotor arm joint to a plurality of corresponding latch receivers positioned.

### CROSS-REFERENCE TO RELATED APPLICATIONS

This application is based on, and claims priority to U.S. Provisional Application No. 63/074,036, filed Sep. 3, 2020, the entire contents of which being fully incorporated herein by reference.

### TECHNICAL FIELD

The present disclosure relates generally to the technical field of aviation and aircraft. Particularly, the present disclosure relates to unmanned aircraft colloquially referred to as drones.

### BACKGROUND OF THE INVENTION

New and evolving commercial applications of unmanned aircraft include: the visual and hyperspectral inspection of electrical transmission lines and natural gas pipelines, intrastate package delivery, the deployment of life saving medical supplies, as well as the patrol and reconnaissance of national border areas. UA engineers and manufacturers are tasked with the dual mandate of meeting the demand for aircraft requiring mission-specific capabilities while complying with federal regulations and guidelines. Companies have the potential to see significant economic benefits when a balance between these mandates is found by maximizing newly developed technologies that meet job requirements while still operating within governmental regulatory frameworks.

For example, in the U.S. alone it is estimated that the electrical grid consists of 200,000 miles of high voltage transmission lines, and 5.5 million miles of local distribution lines. Many public utilities are required by states to complete a visual inspection of each power line every 1-2 years and a detailed inspection every 3-5 years. These inspections are expensive, time-consuming and are typically completed by one of three methods: on foot, by vehicle, or manned aircraft. To add to that, longer inspection times and higher expenses result when power lines and towers are located in remote areas and on rough terrain. Currently most utility companies are opting for helicopter-based power line inspections, which can cost upwards of $6,000 U.S. per day for an average contract. Utilization of a properly equipped UAS can save companies approximately 75% of this cost.

Following the above example, capturing these potential savings means improving efficiencies in asset management on a large scale and can require automating the inspection processes. Automation can be achieved through the integration of advanced sensors attached to the UAV. Technological improvements in the sensors that can be deployed on UAVs, which can enhance the inspection processes in several ways, such as: high-definition and hyperspectral visual inspections, thermal imaging, assessing storm damage, construction site mapping, construction tracking, analysis of vegetation encroachment and monitoring right-of-way issues. The integration of these sensors with UAVs can facilitate and improve the performance of sensors through precise low altitude flight and hovering, and the rapid deployment of air assets in remote areas and rough terrain. The mission-specific needs of a commercial application such as power line inspections dictate the required flight characteristics or capabilities needed in an aircraft platform. The economic practicability or benefit of utilizing UAVs in such an application requires the maximization of those aircraft's flight capabilities.

The three primary capabilities of an UAV that predict its potential economic benefits are: flight time (endurance), range (distance), and payload (weight capacity). The primary capabilities combined can formulate an operator's potential hourly revenue.

Conversely, every UAV platform is also considered in the context of additional characteristics that may have a directly negative impact on its potential economic benefit if left unmitigated by proper design and materials science. These characteristics include: the strength and reliability of parts, deployment ability, the frequency of routine or major maintenance, and the way that maintenance can be effectuated. The potential expenses related to these characteristics combined can formulate an operator's expenses and can reduce potential hourly revenue.

Further, the ability to realize the economic benefit of an UAV in the context of its operation is to maximize its capabilities (potential hourly revenue) and minimizing the unique characteristics that increase expenses. This economic realization can be dependent on three main aircraft systems: a consistent and efficient source of power; precise and redundant flight control systems; and an effective airframe design.

### SUMMARY

The disclosure of the present application describes in part an airframe for unmanned aerial vehicles (UAVs). Value creation, in the context of airframe design, can be considered in terms of generating the greatest overall utility of UAV in a supporting role to an aircraft power plant and flight control systems. Through the combination of technical disciplines such as aerodynamics and materials technology, with a focus on weight and strength, the unique innovation of the invention presently disclosed addresses mission specific requirements of an UAV while improving aircraft capabilities. The result is a pragmatic economic benefit to commercial operators - prolonged mission duration, expanded mission functionality, and lower operating expense, and larger return on investment.

### Endurance

The airframe of the present disclosure is capable of remaining airborne for extended periods of time (e.g., as expressed in flight time). The more time an aircraft can fly between landings or fuel cycles while completing the required tasks, the more revenue it will generate. For example, the goal of an unmanned airborne inspection of large-scale assets is to prolong mission duration as much as possible, which can increase revenue. The available flight time of an UAV has many variables including external ones such as: wind, temperature, and altitude. However, all things being equal, the maximum flight time of an UAV can be viewed as a function of power (thrust) available, fuel efficiency, fuel capacity and total aircraft weight. In the context of airframe design, the UAV endurance is enhanced by a reduction in overall weight and aerodynamic drag, which is accomplished by the airframe of the present disclosure.

### Range

The airframe described herein is also capable of being operated at the greatest possible range or distance from the pilot or ground control station (GCS). The range of an UAV is directly correlated to the continuity of RF and GPS based flight control systems. As such, the airframe, and corresponding UAV, presently disclosed may be integrated with a command and control vehicle with enhanced RF capabilities, such as those described in U.S. Patent App. No. 63/011,600, which is hereby incorporated by reference in its entirety.

The functional range of UAV is also dependent on available flight time and thus also correlated to power available, weight, and aerodynamic drag. The airframe design also enhances a UAV's available flight time by reducing overall weight and aerodynamic drag.

### Payload

The airframe described in the present disclosure is also capable of maximizing the UAV payload to complete the mission as required or increase the number of functions available to the operator. The maximum available payload is the difference between the maximum gross take-off weight of the UAV less the empty weight of the UAV (to include operating fluids). In the context of airframe design, the useful payload of an UAV is directly correlated both by weight and space considerations.

### Additional Characteristics in Airframe Design

The airframe described herein can also improve performance and reduce expense in other ways. For example, the airframe can include a layout of design components capable of streamlining the integration of systems. In another example, parts and components of the airframe include the dual requirement of meeting strength and reliability constraints while not reducing valuable payload by adding unnecessary weight. The strength and reliability of components and parts specific to the airframe are directly correlated to service life, time before overhaul (TBO), and unscheduled maintenance. The process through which maintenance is performed can be enhanced by the design of the airframe, which, if more efficient generally, can increase economic benefits. The manner in which a mechanic interacts with the airframe is directly enhanced through the design and layout of the airframe. The deploy ability of an UAV reduces non-revenue time on the ground by taking into consideration the human factors with which the operator interacts with the machine, in other words, how easy it is to use.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a side view of the an unmanned aerial vehicle (UAV) according to an embodiment of the claimed invention.

FIG. 2 depicts a front view of an UAV according to an embodiment of the claimed invention.

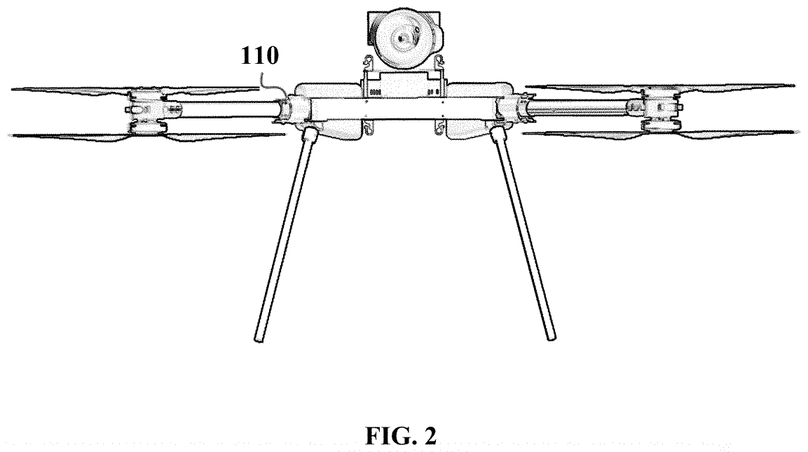

FIG. 3 depicts a top view of an UAV according to an embodiment of the claimed invention.

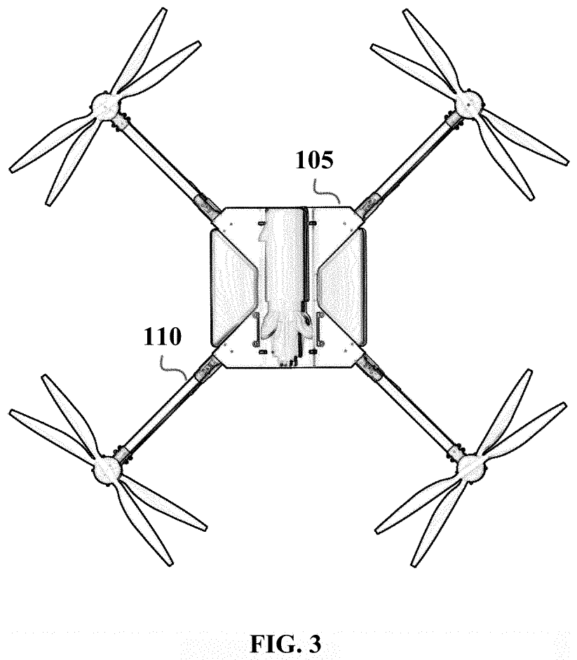

FIG. 4 depicts fuselage main bodies for an UAV according to embodiments of the claimed invention.

FIG. 5 depicts fuselage power plant mounting systems according to embodiments of the claimed invention.

FIG. 6 depicts fuselage internal assemblies according to embodiments of the claimed invention.

FIG. 7 depicts fuselage fuel tanks for use with a fuselage main body according to embodiments of the claimed invention.

FIG. 8 depicts fuselage fuel tank mounted to a fuselage main body according to embodiments of the claimed invention.

FIG. 9 depicts payload mounting systems of a fuselage main body according to embodiments of the claimed invention.

FIG. 10 depicts fuselage center assemblies according to embodiments of the claimed invention.

FIG. 11 depicts center hub matrices according to embodiments of the claimed invention.

FIG. 12 depicts rotor arms coupled to a fuselage main body according to an embodiment of the claimed invention.

FIG. 13 depicts rotor arms and fuselage center assemblies according to embodiments of the claimed invention.

FIG. 14 depicts distal ends for rotor arm and joint assemblies according to embodiments of the claimed invention.

FIG. 15 depicts rotor arm and joint assemblies in an open and closed position according to embodiments of the claimed invention.

FIG. 16 depicts deconstructed rotor arm joint assemblies according to embodiments of the claimed invention.

### DEFINITIONS

The instant invention is most clearly understood with reference to the following definitions.

“Ground control station” means an interface used by a remote pilot to control the flight path of an unmanned aircraft.

“Small unmanned aircraft” (sUA) means an unmanned aircraft weighing less than 55 pounds on takeoff, including everything that is on board or otherwise attached to the aircraft.

“Small unmanned aircraft system” (sUAS) means a small unmanned aircraft and its associated elements (including communication links and the components that control the small unmanned aircraft) that are required for the safe and efficient operation of the small unmanned aircraft in the national airspace system.

“Unmanned aerial vehicle” (UAV) means an aircraft operated without the possibility of direct human intervention from within or on the aircraft.

“Visual observer” (VO) means a person who is designated by the remote pilot in command to assist the remote pilot in command and the person manipulating the flight controls of the small UAS to see and avoid other air traffic or objects aloft or on the ground.

“Commercial Operator” means a person who, for compensation or hire, engages in the carriage by aircraft in air commerce of persons or property, other than as an air carrier or foreign air carrier.” “Where it is doubtful that an operation is for “compensation or hire,” the test applied is whether the carriage by air is merely incidental to the person's other business or is, in itself, a major enterprise for profit.”

“Airframe” means the fuselage, booms, nacelles, cowlings, fairings, airfoil surfaces (including rotors but excluding propellers and rotating airfoils of engines), and landing gear of an aircraft and their accessories and controls.

“Fuselage” means the aircraft's main body

“Payload” refers to the part of a vehicle's load, especially an aircraft's, from which revenue is derived, passengers and cargo.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

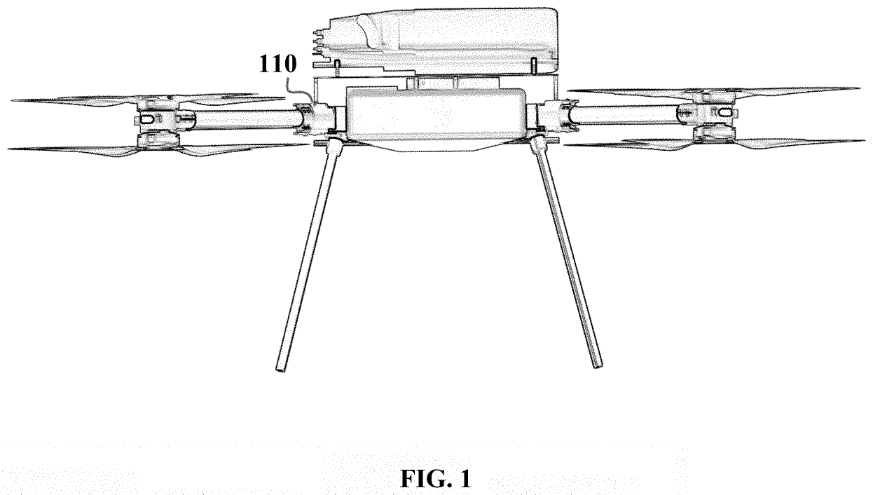

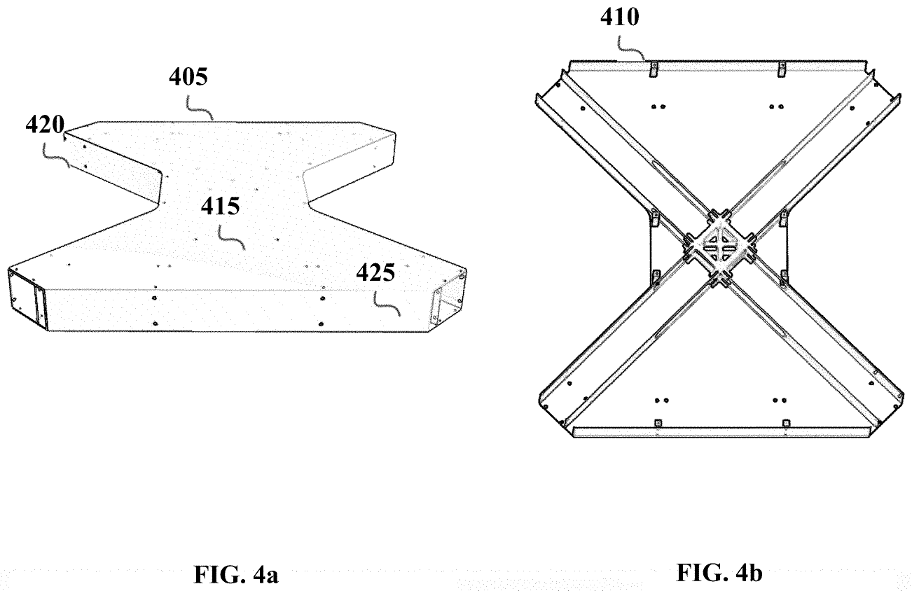

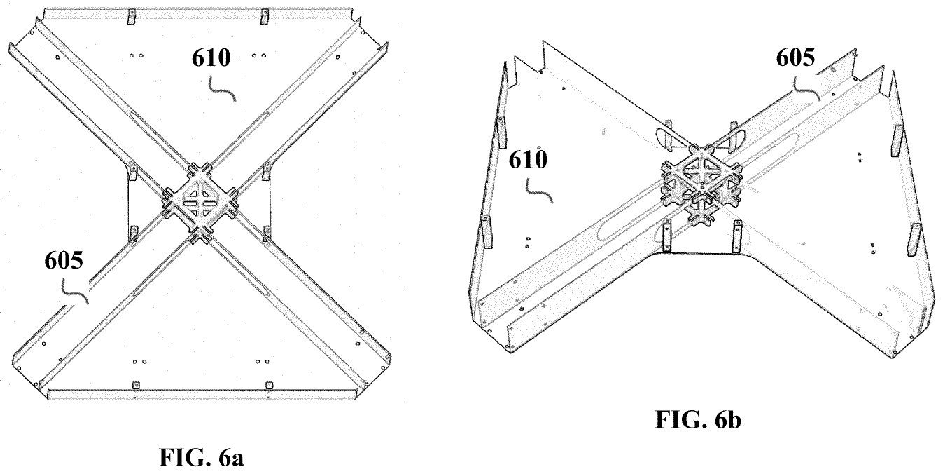

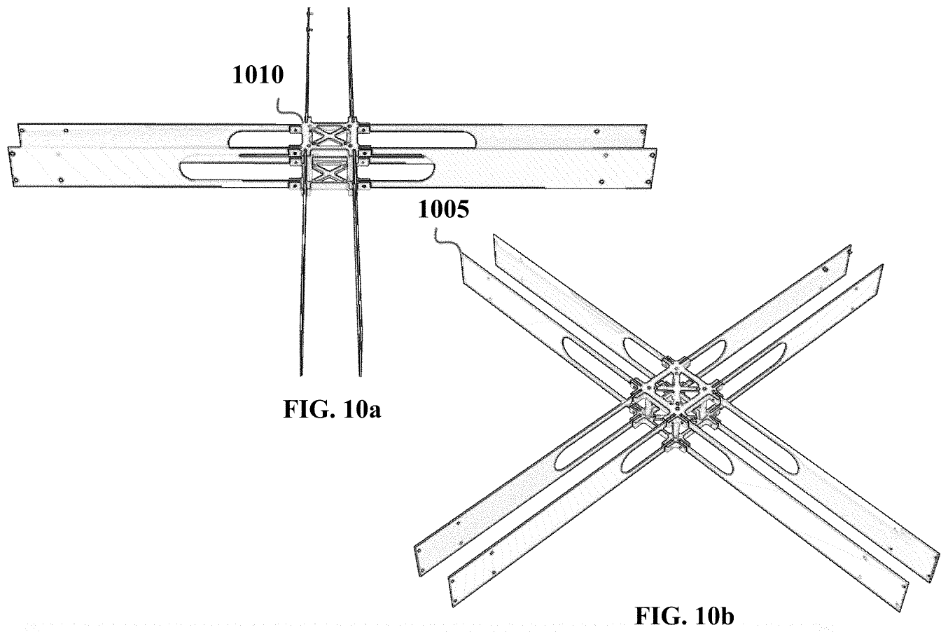

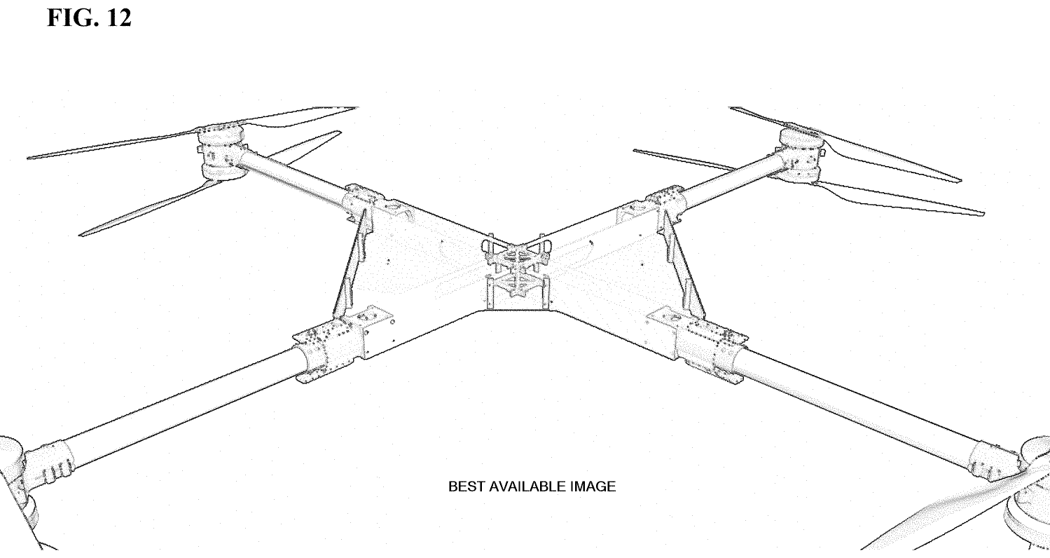

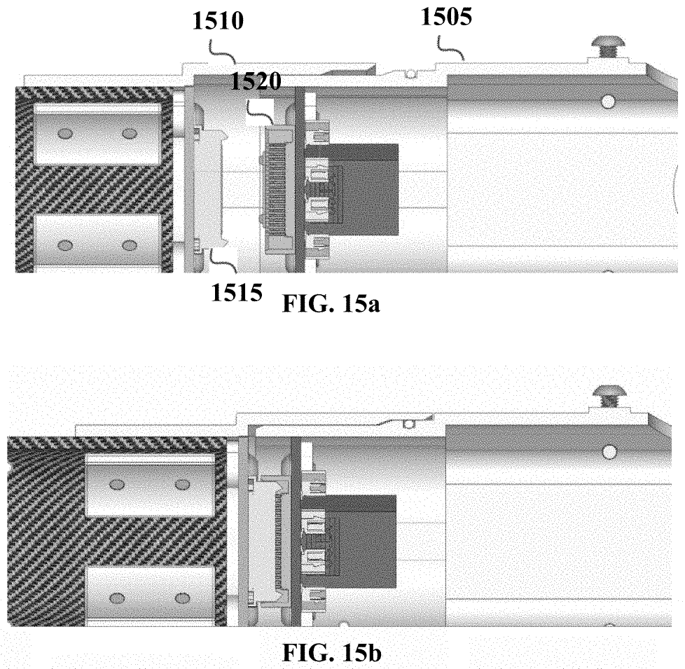

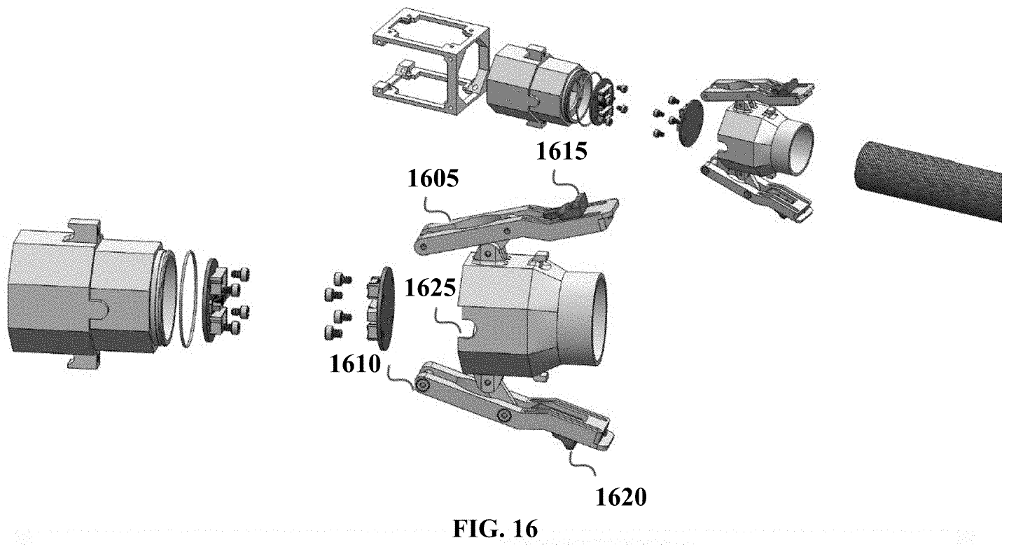

Described herein are components and assembly of an unmanned aerial vehicle (UAV). FIGS. 1 -3 depict various perspective of an UAV according to embodiments of the claimed invention. Typically, the airframe refers to the fuselage (aircraft's main body), booms, nacelles, cowlings, fairings, airfoil surfaces (including rotors but excluding propellers and rotating airfoils of engines), and landing gear of an aircraft and their accessories and controls. The distinct elements of the airframe invention described herein are best exemplified in three main components: the fuselage main body 105 (also shown in FIGS. 4-9); the fuselage center assembly (shown in FIGS. 6 and 10-12); and the rotor arm and joint assembly 110 (also shown in FIGS. 12-16).

### Fuselage Main Body

The design of the airframe's fuselage consists of a uniquely shaped irregular and concave dodecahedron main body, depicted in FIG. 4a. The fuselage can be a semi-monocoque structure embodying an outer shell 405 and an internal center hub structure 410 (e.g., depicted in FIG. 4b). The fuselage outer shell 405 may be made of one or more composite materials, e.g. carbon fiber, or a suitable plastic or polymer, and the like. The fuselage outer shell 405 can consist of a superior side 415 (top plate), an inferior side 420 (bottom plate) as well as a plurality of vertical sides 425 (e.g., twelve, in the case of a dodecahedron). The resulting unique shape is a twelve-sided semi-monocoque, box-like fuselage. To improve the UAV's operating capabilities and to reduce expense, the design and construction of the fuselage main body is driven by five key parameters:
1a. Improve strength and reliability, decrease weight
1b. Integrate and enhance the hybrid micro gas turbine power plant
1c. Create internal waterproof/dustproof spaces for sensitive components
1d. Augment fuel tank installation and center of gravity
1e. Maximize payload integration
   1a. Improve Strength and Reliability, Decrease Weight

The first parameter addresses the need to maximize UAV endurance and range, while not sacrificing the overall strength and reliability of the main body through light-weight construction. In powered flight the fuselage is subjected to the torsional stress of aerodynamic forces as well as the high frequency vibrations created by the power plant, motors, and rotors. Utilizing plates of composite material for the fuselage outer shell 405 has the advantage of a lightweight composite materials' superior tensile strength as well as an improved elastic modulus compared to other forms of composite materials. The entirety of the superior or inferior side plates are each machined from a single piece of composite material to eliminate the necessity of joints in the fuselage. This improves the strength and reliability of the two primary fuselage main body parts while maintaining the flexibility required to withstand stress and vibration with a light-weight solution.

1b. Integrate and Enhance the Hybrid Micro Gas Turbine Power Plant

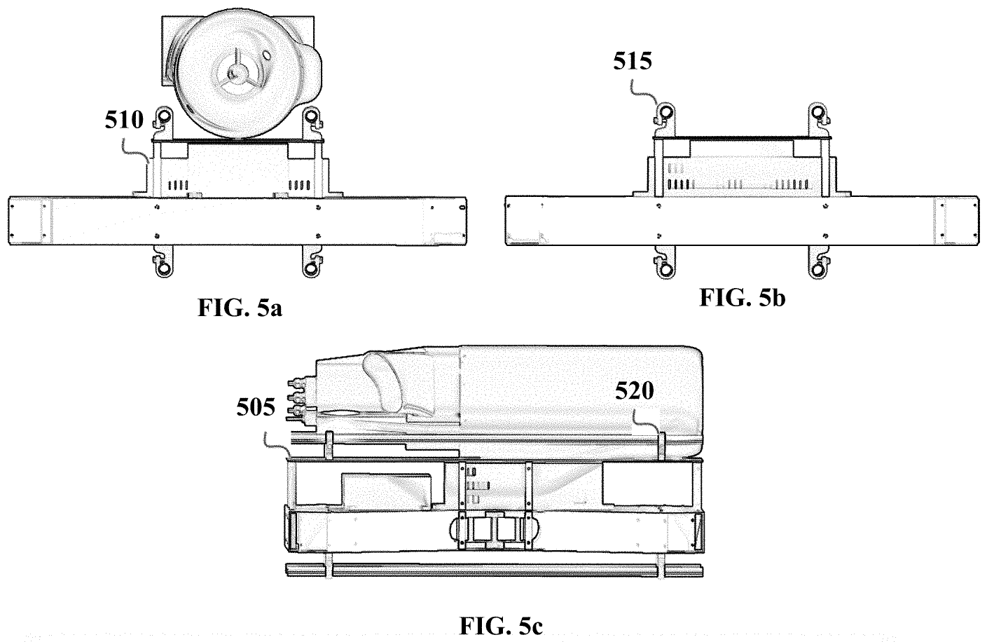

The second parameter is to provide a method and system for the mounting/installation of the aircraft power plant, in this case a hybrid micro gas turbine motor and generator as depicted in FIG. 5, which can improve the UAV's overall capability. Special consideration has been made in the installation design with a focus on turbine engine performance, torsional stress, vibration, heat management, as well as providing easy access for mechanical service or intervention. The superior side mounting configuration of the power plant permits unrestricted airflow, e.g., through channel 505 defined by the inferior surface of the power plant and the superior surface of a mounting plate, in forward flight into the micro turbine's first stage air compressor (depicted in FIG. 5c). The unrestricted airflow can improve overall fuel efficiency and power output thereby increasing endurance, range, and payload.

The primary means of power plant mounting and installation can be achieved mechanically via the turbine mounting plate 510 (fixed to the superior surface of the fuselage body), rail clamp assembly (e.g., a plurality of rail clamps 515 coupled to a superior surface of the turbine mounting plate), and one or more vertically positioned square standoffs. The standoff attachment points can consist of threaded screws and vertical posts made of aircraft grade aluminum or magnesium. The vertical posts can transect the elevated mounting plate, and superior side terminating at the inferior side of the fuselage body. The vertical posts and mechanical attachments can function to secure the power plant to the main body as well as reduce the force of stress and vibration to the vertical sides of the main body.

The area created between the turbine mounting plate and the superior side of the fuselage main body can provides a space for components required for the operation of the micro gas turbine, such as a full authority digital engine controller (FADEC), a power management unit (PMU), and a battery array.

The superior side installation of the turbine mounting system can provide easy access to authorized maintenance personnel in the case of routine maintenance, engine overhaul and or engine replacement. This simple yet effective approach can reduce maintenance related out-of-service time, thereby improving the economics of operations. Further benefits can include the powerplant mounted on top of the airframe, thereby giving unrestricted field of view for the payload. Further, in some cases the exhaust can be vented away from the payload.

1c. Create Internal Waterproof/Dustproof Spaces For Sensitive Components

The third parameter considered in the fuselage design for maximizing the continuity of flight operations and increasing the longevity of aircraft components is to create secure and separate internal spaces for furnishing the aircraft's electrical wiring and plumbing. The internal configuration of the fuselage main body can consist of one or more segregated spaces and one or more channel type enclosures. For example, in the embodiment depicted in FIG. 6 the internal configuration of the fuselage main body includes of a total of six segregated spaces, four independent channel type enclosures 605, and two larger areas 610 fore and aft of the center hub matrix. The four channels extend diagonally from the fuselage center of mass at the proximal ends outward and are a dedicated conduit for the electrical wiring that runs to/from the power plant and its subsystems to each of the four motors. The additional two areas can facilitate space for additional PCB's and electrical wiring. Each of the spaces can be formed by vertical partitions created by the truss walls of the center hub assembly and the outer shell walls. The structural nature of these components is treated as a separate assembly and will be discussed in greater detail in the fuselage center hub assembly section.

Commercial flight operations in some cases may require that aircraft and associated components may be exposed to diverse set weather systems, environmental conditions and hazardous materials. The seams of the outer shell and internal structure can be mechanically compressed via the one or more vertical posts 520 and threaded fasteners to create a sealed enclosure. The joints created by the sandwiching of the superior and inferior sides to both the vertical side walls as well as the truss brackets are further sealed with one or more synthetic materials, which can achieve a watertight enclosure for the integrity of electrical components. The enclosed electrical components may thus be protected from the environment (e.g., rain, dust, pollutants). The isolated compartments formed by the enclosures increase the service life and/or reliability of the electrical system, thereby reducing the probability of added costs associated with repairs or aircraft out-of-service time.

1d. Augment Fuel Tank Installation and Center of Gravity

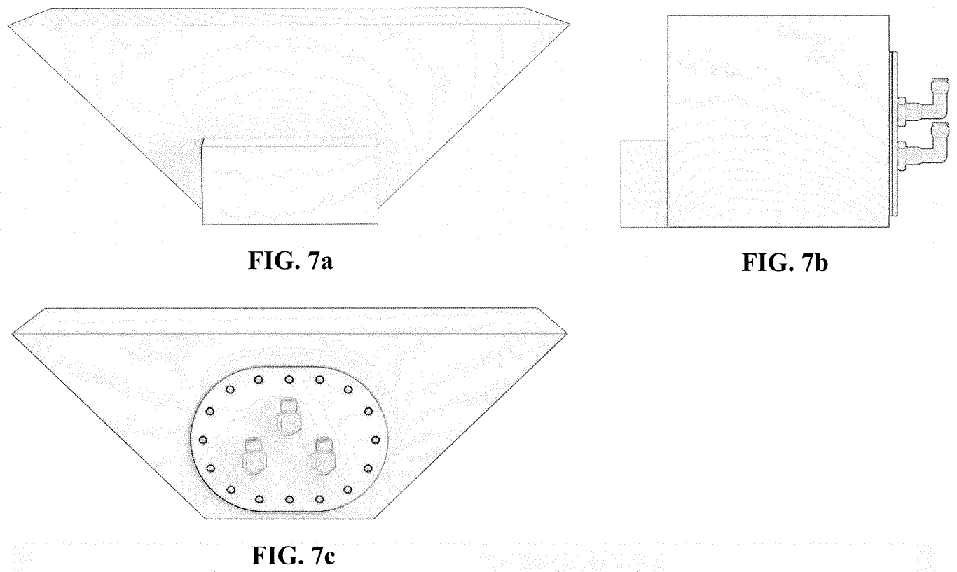

Liquid fuels and fuel systems used in hybrid UAVs are a significant source of the total max takeoff gross weight and fuel system installation has the potential to enhance or reduce overall aircraft performance. The distinct configuration of the fuselage main body allows for the installation of fuel tanks in the shape of convex quadrilateral, such as an isosceles trapezoid and the like, as depicted in FIG. 7. The fuel tanks may be made of one or more composite materials and may have an internal baffling or bladder type structure to reduce fuel sloshing or negative impacts to aircraft center of gravity caused by the movement of fuel. The fuel tanks may be of varying volumes (by height) which may increase or decrease endurance, range, and/or payload profiles without significant mechanical intervention to the aircraft or a meaningful shift in the longitudinal center of gravity.

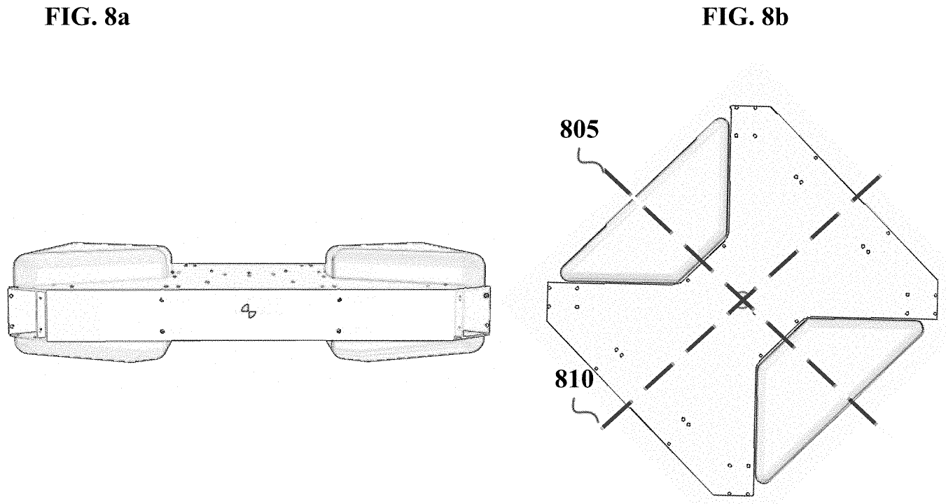

The UAV's reference datum or the point from which arms and moments are calculated for center of gravity consideration, lies directly at the intersection of the medial 805 and lateral 810 lines of the fuselage main body depicted in FIG. 8. In many aircraft the center of gravity (CG) shifts in the normal course of adding fuel or through fuel consumption in flight. A shift in the CG may create the need for ballast (added weight), increased thrust, or decreased airspeed to correct for this occurrence. These actions may reduce endurance, range, and payload available.

Additionally, most aircraft cannot alter the fuel capacity by volume without impacting the CG or overall design of the fuselage. There are four primary benefits of an interchangeable fuel system and integration in the present invention. First, that fuel capacity can be increased (by fuel tank size), extending range and endurance to maximum levels without a negative impact on center of gravity. Second, that fuel capacity and fuel tank weight can be decreased (by fuel tank size), maximizing payload when needed. Three, that fuel tanks can be switched without significant mechanical intervention. For example, small openings in the bottom plate can allow the fittings to exit out of the bottom. The top plate can include a strip of carbon that can wrap around the tank to secure the tank and can mitigate lateral movement of the tank. Brackets can secure the tank to the frame via fasteners and adhesive. Four, that there is no meaningful shift in the longitudinal CG during normal flight operation.

Additional benefits of the present fuel system integration have a reduced impact on aerodynamic drag. The distinct shape of the fuel tanks fits into the three-sided indentations on the lateral sides of the fuselage outer shell. As a result, the fuel tanks do not protrude past the lateral planes of the port and starboard sides of the fuselage main body, as depicted in FIG. 8b. The distinct shape of the fuel tanks is also considered in the context of protruding too far above or below the fuselage upper deck and lower decks respectively, as depicted in FIG. 8a. The first of two primary benefits of the unique design of the fuel tanks and fuel system design in the present disclosure is that the mounting of fuel tanks relative to both the lateral and vertical planes of the fuselage does not interfere with the circulation of air from the UAs rotors and does not reduce overall thrust or lift. The second primary benefit is that the design results in maximum reduction of profile drag, improving aerodynamic characteristics and therefore greater fuel efficiency (improved range and endurance).

1e. Maximize Payload Integration

The distinct design of the fuselage main body creates the ideal system for loading and unloading payloads of varying types. The current design has considered a maximum payload use in three ways. First, the fuel supply is integrated into the lateral areas of the fuselage main body. Second, the powerplant and associated control systems are mounted on the superior surface of the fuselage main body. Three, most of the electrical wiring and plumbing has been moved to the interior structure of the fuselage main body.

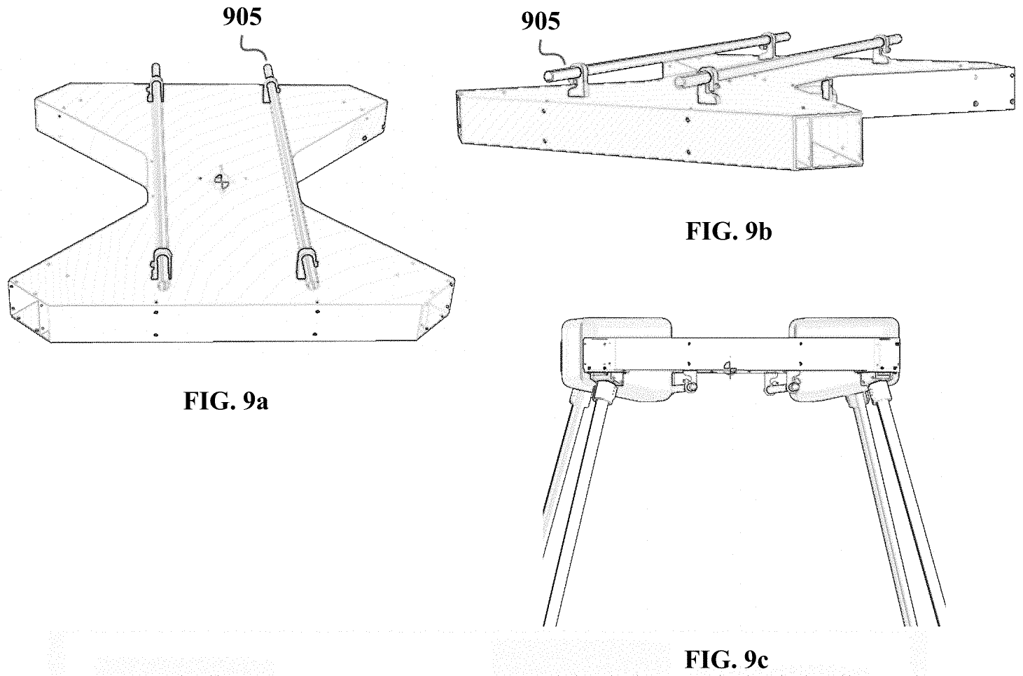

This unique configuration provides the significant volume below the inferior side of the main body for the mounting of a variety of payloads. This volume can be seen in FIG. 9c. Loading and unloading of payloads can be accomplished via horizontal rail type supports 905 consisting of composite material round stock and used in conjunction with quick release rod clamp/rail block devices.

### Fuselage Center Hub Assembly

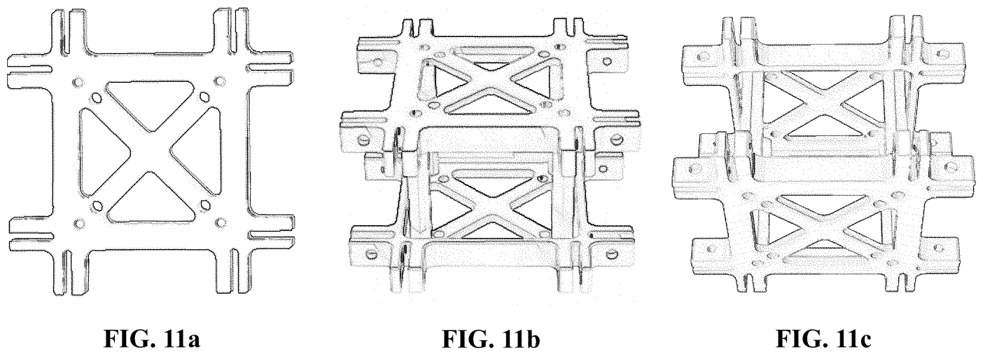

The center hub assembly is the primary internal structure of the fuselage and generally resembles a hub-and-spoke arrangement, including multiple “spokes” channels radiating from a lattice center hub structure. Specifically, the center hub assembly can include center hub truss brackets 1005 and the center hub matrix 1010. FIG. 11 depicts in more detail an embodiment of the center hub matrix, including the cavities formed via the matrix lattices. As previously described, the center hub truss brackets can create separate enclosed conduits for electrical components. In addition to this advantage, each of the channels formed by truss brackets can increase the rigidity and overall strength of the airframe. The center hub truss brackets may be made of one or more composite materials, including carbon fiber or a suitable plastic or polymer.

The intersection of the respective channels occurs at each respective proximal end, where each proximal end can be secured to the superior and inferior sides of the lattice structure of the center hub matrix. The center hub matrix can be milled from aircraft grade aluminum or magnesium. Each of the truss brackets is connected mechanically to the center hub matrix at multiple points , for example via threaded screws.

The distal end of the channel is attached to and reinforced by the fuselage outer shell as well as the mounting of each arm joint assembly, then further to the motors and propellers which extend radially outward from the fuselage, as depicted in FIG. 12. The combined design of the internal assembly and outer shell is a lightweight semi-monocoque solution to distribute the forces generated by the motors at the distal ends equally across the entire fuselage and its reinforced center. This also enhances the overall strength and longevity of the fuselage in a weight-efficient design.

### Rotor Arm and Joint Assembly

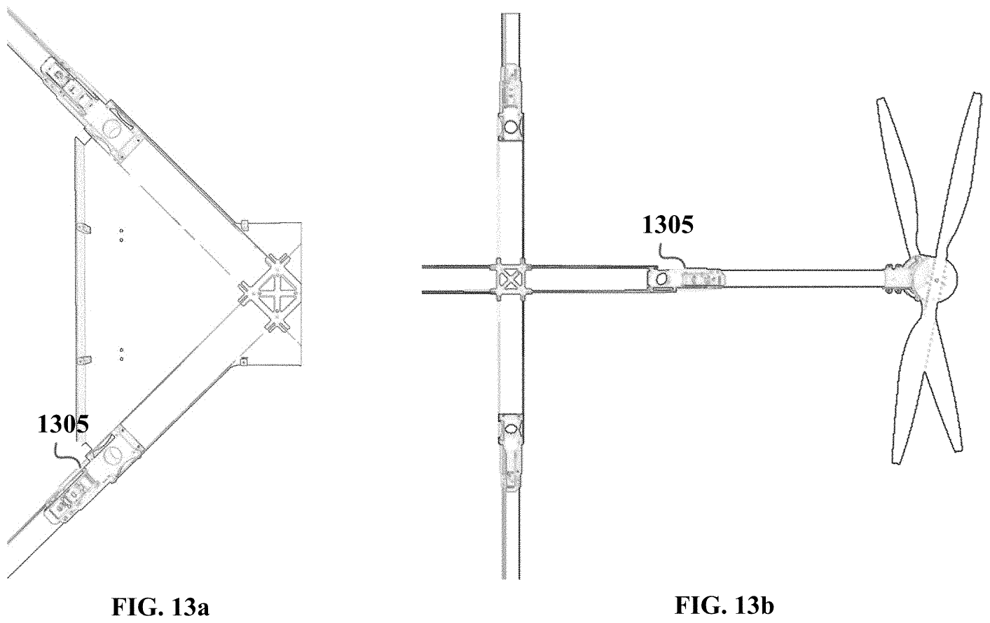

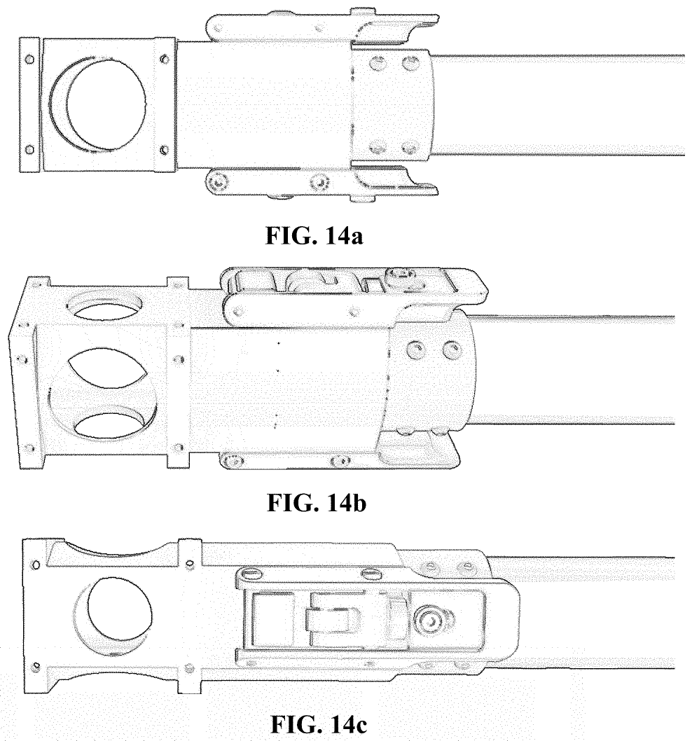

The proximal end of the rotor arm assembly terminates at the distal end of the center hub assembly, as shown at points 1305. The UAV motors and rotor assemblies are mounted at the distal end of the rotor arm, as depicted in FIG. 13b. The rotor arm may be made from round or other stock (e.g., octagonal stock, and the like) of one or more composite materials, e.g. carbon fiber, or a suitable plastic or polymer. The connection of the rotor arm assembly to the center hub assembly is made mechanically via a unique quick release detachable and/or folding rotor arm joint, shown in more detail in FIG. 14.

The rotor arm and joint assembly can be designed for use with four co-axial motors and eight rotors for both mechanical redundancy and aerodynamic efficiency. However, the same assembly can be utilized with a standard motor and four rotors. The arms may be folded down vertically and perpendicular to the fuselage or removed from the aircraft entirely. The benefit of the folding mechanism is to assist in the quick deployment of the UAV from site to site. However, the rotors arms can be quickly removed for shipping, extended transport, and maintenance. The rotor arm joint can include an inner 1505 and outer 1510 arm assembly as well as inner 1515 and outer 1520 arm PCB. Further the arm joint can include: an upper 1605 and lower 1610 quick release latch mechanism, dual locking latches 1615 and 1620 and a key mechanism 1625 to prevent incorrect installation. In some cases, the arm joint can also include a proximal end arm joint housing and mounting bracket, a distill end arm joint housing, and arm joint PCBs at both the proximal and distill ends of the connection.

There are multiple technical benefits to the rotor arm joint design presently disclosed. One, the inner and outer and arm assemblies each accommodate PCBs utilizing a 40-pin connector device; redundant electrical power connections and data connections. Many commonly used rotor arm PCBs utilize only 12 pins. This added capability greatly increases the redundancy of telemetry that that can transmitted from the UA motors back to the flight computer and autopilot.

Second, the tolerances between the inner and outer assemblies of the joint connection are much smaller compared to standard connections commonly available in the commercial market. Connectors with greater tolerance for movement in all three planes are more susceptible to: loss of telemetry, electrical spikes, increased risk of damage caused by debris and water, and degradation from aircraft vibrations.

Mechanically the secure connection between rotor arm joints can be effectuated in one second. Comparative removable arm systems utilize threaded screws or wingnut type hardware. These devices often require a tool to assemble, take longer to setup, and risk costly damage to the arm through the process of assembly. Rapid assembly improves UAV deployment times, decreases accidents, and eases the replacement and maintenance of rotor arms. More permanent folding arm mechanisms require more time to service and replace resulting in more out of service time.

The overall application of materials science and design configurations with a focus on weight, strength, reliability, and maintenance considerations enhance the integration of a hybrid microturbine power plant. However, the pragmatic and effective design of the UAV in this present disclosure makes integration with a variety of commercially available of engines and engine types possible.

1. A main body for an unmanned aerial vehicle (UAV), comprising:
a fuselage outer shell defining a lateral axis, a longitudinal axis, and a plurality of sides, wherein one or more of the plurality of sides are concave with respect to the lateral axis or the longitudinal axis.

2. The main body of claim 1, wherein the plurality of sides comprises a dodecahedron.

3. The main body of claim 1, wherein the fuselage outer shell further defines a cavity between a superior surface, an inferior surface, and the plurality of sides.

4. The main body of claim 1, further comprising:
a turbine mounting plate coupled to a superior surface of the fuselage outer shell.

5. The main body of claim 4, further comprising:
a plurality of rail clamps coupled to the turbine mounting plate and configured to couple a UAV power plant to the main body.

6. The main body of claim 4, further comprising:
a plurality of standoff posts, wherein each standoff post transects the mounting plate and a superior surface of the fuselage outer shell, wherein each standoff post is configured to couple a UAV power plant to an inferior surface of the fuselage outer shell.

7. The main body of claim 1, wherein each concave side of the fuselage outer shell is configured to receive a fuel tank.

8. The main body of claim 7, wherein the fuel tank is of a convex quadrilateral shape.

9. The main body of claim 1, further comprising:
a plurality of rail supports along an inferior surface of the fuselage outer shell, wherein each rail support is configured to couple to a payload for the UAV.

10. A fuselage center assembly for an unmanned aerial vehicle (UAV), comprising:
a lattice center defining a superior surface and an inferior surface; and
a plurality of channels, each channel having a proximal end and a distal end, wherein each proximal end is coupled to the superior surface and the inferior surface.

11. The fuselage center assembly of claim 10, wherein each distal end is coupled to a fuselage outer shell.

12. The fuselage center assembly of claim 10, wherein each channel comprises a plurality of truss brackets.

13. A rotor arm and joint assembly for an unmanned aerial vehicle (UAV), comprising:
a rotor arm having a proximal end and a distal end;
a motor and rotor system coupled to the distal end of the rotor arm; and
a rotor arm joint coupled to the proximal end of the rotor arm, wherein the rotor arm joint further comprises:
an outer shell; and
a plurality of quick release latches coupled to the outer shell and configured to couple the rotor arm joint to a plurality of corresponding latch receivers.

14. The rotor arm and joint assembly of claim 13, wherein the quick release latch is coupled to the outer shell via a hinge.

15. The rotor arm and joint assembly of claim 13, further comprising:
a lock assembly, comprising:
a sliding latch coupled to the quick release latch and configured to be repositionable along a length of the quick release latch; and
a sliding latch receiver configured to receive the sliding latch, wherein the quick release latch is unable to reposition with respect to the outer shell of the rotor arm joint when the sliding latch is received by the sliding latch receiver.

16. The rotor arm and joint assembly of claim 13, wherein the motor and rotor system comprises four co-axial motors and eight rotors, or a motor and four rotors.

17. The rotor arm and joint assembly of claim 13, wherein the rotor arm joint further comprises a hinge, wherein the rotor arm joint is configured to reposition a positioning of the motor and rotor system with respect to the rotor arm joint.

18. An unmanned aerial vehicle (UAV), comprising:
a fuselage outer shell defining a lateral axis, a longitudinal axis and a plurality of shell sides, wherein a plurality of the shell sides are concave with respect to the lateral axis or the longitudinal axis;
a fuselage center assembly positioned within a cavity defined by the fuselage outer shell, the fuselage center assembly comprising:
a lattice center defining a superior surface and an inferior surface; and
a plurality of channels, each channel having a proximal end and a distal end, wherein each proximal end is coupled to the superior surface and the inferior surface; and
a rotor arm and joint assembly comprising:
a rotor arm having a proximal end and a distal end;
a motor and rotor system coupled to the distal end of the rotor arm; and
a rotor arm joint coupled to the proximal end of the rotor arm, wherein the rotor arm joint further comprises:
an outer shell; and
a plurality of quick release latches coupled to the outer shell and configured to couple the rotor arm joint to a plurality of corresponding latch receivers positioned on either the fuselage center assembly or the fuselage outer shell.
